(19) United States
(12) Patent Application Publication
(10) Pub. No.: US 2018/0264613 A1
(43) Pub. Date: Sep. 20, 2018

(54) ABNORMALITY DETECTION APPARATUS AND MACHINE LEARNING APPARATUS

(71) Applicant: FANUC CORPORATION, Yamanashi (JP)

(72) Inventors: Takayuki TAMAI, Yamanashi (JP); Shinji OKUDA, Yamanashi (JP)

(21) Appl. No.: 15/920,629

(22) Filed: Mar. 14, 2018

(30) Foreign Application Priority Data
Mar. 15, 2017 (JP) 2017-050080

(51) Int. Cl. B23Q 17/00; G06N 99/00

(52) U.S. Cl. CPC B23Q 17/007; B23Q 2717/00; G06N 99/005

(57) ABSTRACT

An abnormality detection apparatus includes a machine learning apparatus for learning waveform data concerning a physical quantity detected when a machine tool is normally operating. The machine learning apparatus observes the waveform data concerning the physical quantity detected when the machine tool is normally operating, as a state variable indicating a current environmental state, and learns a feature of the waveform data concerning the physical quantity detected when the machine tool is normally operating, using the observed state variable.

### BACKGROUND OF THE INVENTION

### 1. Field of the Invention

The present invention relates to a machining state abnormality detection apparatus and a machine learning apparatus.

### 2. Description of the Related Art

In machine tools, tool wear or breakage, machining load variation, a change in a machining environment such as cutting fluid, disturbance, or the like may cause a machining failure. There are cases where the remachining of a machined workpiece causes a machining failure. These cannot be said to be a normal machining state. It is desired that these machining state abnormalities are detected so that the occurrence of a machining failure can be determined before the occurrence thereof.

As a prior art technique for detecting a machining state abnormality, for example, Japanese Patent Application Laid-Open No. 2007-52797 discloses a technique that sets sampling points in accordance with a program and machining details in advance, and compares data acquired when machining is performed a plurality of times by calculating an average value and a standard deviation value for each sampling point to detect a machining state abnormality. Further, Japanese Patent Application Laid-Open No. 05-285788 discloses a technique that stores data on operation states when predetermined operation is normally performed in advance, causes predetermined operation to be performed when an inspection is performed, and compares data on an operation state in a normal state for this predetermined operation with monitoring data at the time of inspection to determine whether operation is normal or not.

However, in the technique disclosed in Japanese Patent Application Laid-Open No. 2007-52797, there is a problem in that sampling points need to be set in accordance with a specific program and machining details in advance and an abnormality cannot be detected independently of machining details and the like. Further, in the technique disclosed in Japanese Patent Application Laid-Open No. 05-285788, there is a problem in that predetermined operation needs to be executed at the time of inspection and this technique cannot be applied to abnormality detection at the time of machining.

### SUMMARY OF THE INVENTION

Accordingly, an object of the present invention is to provide an abnormality detection apparatus and a machine learning apparatus which can detect a machining state abnormality of a machine tool irrespective of machining details.

In the abnormality detection apparatus of the present invention, physical quantities such as speeds and currents of motors, machine vibration, and audible sound during machining are acquired as chronologically successive discrete values to be used as waveform data for one machining cycle or a desired period. Machine learning is performed based on the waveform data acquired when a machine tool is normally operating. Based on the result of the learning, an abnormality state is detected from waveform data obtained when machining is newly performed, and an abnormality of the machining state is determined. Thus, the above-described problems are solved. As the waveform data dealt with in the present invention, chronologically successive discrete values acquired from a machine tool or a sensor or the like attached to the machine tool may be used without change, or data represented in other form in which the waveform can be directly or indirectly represented may be used, such as frequency component values obtained by performing spectral analysis on the waveform data. Further, in the abnormality detection apparatus of the present invention, the waveform data is associated with a program to identify a block in the program in which machining is abnormal. Moreover, in the abnormality detection apparatus of the present invention, a plurality of machine tools performing the same machining share a model, and this allows a machine tool performing abnormal machining to be detected.

An abnormality detection apparatus as one aspect of the present invention detects an abnormality of a machine tool configured to machine a workpiece, and includes a machine learning apparatus for learning waveform data concerning a physical quantity detected when the machine tool is normally operating.

A first form of the machine learning apparatus includes: a state observation section for observing the waveform data concerning the physical quantity detected when the machine tool is normally operating, as a state variable indicating a current environmental state; and a learning section for learning a feature of the waveform data concerning the physical quantity detected when the machine tool is normally operating, using the state variable.

The learning section may include a cluster construction section for constructing a cluster of the waveform data concerning the physical quantity detected when the machine tool is normally operating.

A second form of the machine learning apparatus includes: a state observation section for observing a state observation section for observing waveform data concerning the physical quantity detected when the machine tool is operating, as a state variable indicating a current environmental state; a determination data acquisition section for acquiring determination data indicating normality of operation of the machine tool; and a learning section for performing learning by associating the waveform data concerning the physical quantity detected when the machine tool is operating with the normality of the operation of the machine tool, using the state variable and the determination data.

The learning section may include an error calculation section for calculating an error between a correlation model for deriving the normality of the operation of the machine tool from the waveform data concerning the physical quantity detected when the machine tool is operating and a correlation feature recognized from teacher data prepared in advance, based on the state variable and the determination data, and a model update section for updating the correlation model to reduce the error.

In the first and second forms of the machine learning apparatus, the learning section may have a multi-layer structure to calculate the state variable. The abnormality detection apparatus may further include an output utilization section for outputting an operation state of the machine tool based on a learning result by the learning section and the state variable obtained when the machine tool is operating. The learning section may learn waveform data concerning a physical quantity which is detected when operation is being normally performed and which is common to a plurality of machine tools, using the state variable obtained for each of the plurality of machine tools.

The first form of the machine learning apparatus as one aspect of the present invention learns waveform data concerning a physical quantity detected when a machine tool configured to machine a workpiece is normally operating, and includes: a state observation section for observing waveform data concerning a physical quantity detected when the machine tool is normally operating, as a state variable indicating a current environmental state; and a learning section for learning a feature of the waveform data concerning the physical quantity detected when the machine tool is normally operating, using the state variable.

The second form of the machine learning apparatus as one aspect of the present invention learns waveform data concerning a physical quantity detected when a machine tool configured to machine a workpiece is normally operating, and include: a state observation section for observing waveform data concerning a physical quantity detected when the machine tool is operating, as a state variable indicating a current environmental state; a determination data acquisition section for acquiring determination data indicating normality of operation of the machine tool; and a learning section for performing learning by associating the waveform data concerning the physical quantity detected when the machine tool is operating with the normality of the operation of the machine tool, using the state variable and the determination data.

The present invention enables a machining state abnormality of a machine tool in general machining operation to be detected without causing the machine tool to perform specific operation or without specific machining details.

### BRIEF DESCRIPTION OF THE DRAWINGS

FIG. 1 is a schematic functional block diagram of an abnormality detection apparatus according to a first embodiment.

FIG. 2 is a view illustrating waveform data concerning values detected from a machine tool.

FIG. 3 is a schematic functional block diagram showing another form of the abnormality detection apparatus.

FIG. 4A is a view for explaining a neuron.

FIG. 4B is a view for explaining a neural network.

FIG. 4C is a view for explaining an autoencoder.

FIG. 5 is a schematic functional block diagram of an abnormality detection apparatus according to a second embodiment.

FIG. 6 is a schematic functional block diagram showing one form of a machining system.

FIG. 7 is a schematic functional block diagram showing another form of the machining system.

FIG. 8 is a schematic functional block diagram of the abnormality detection apparatus in the case where supervised learning is used in the first embodiment.

FIG. 9 is a schematic functional block diagram of the abnormality detection apparatus in the case where supervised learning is used in the second embodiment.

### DETAILED DESCRIPTION OF THE PREFERRED EMBODIMENTS

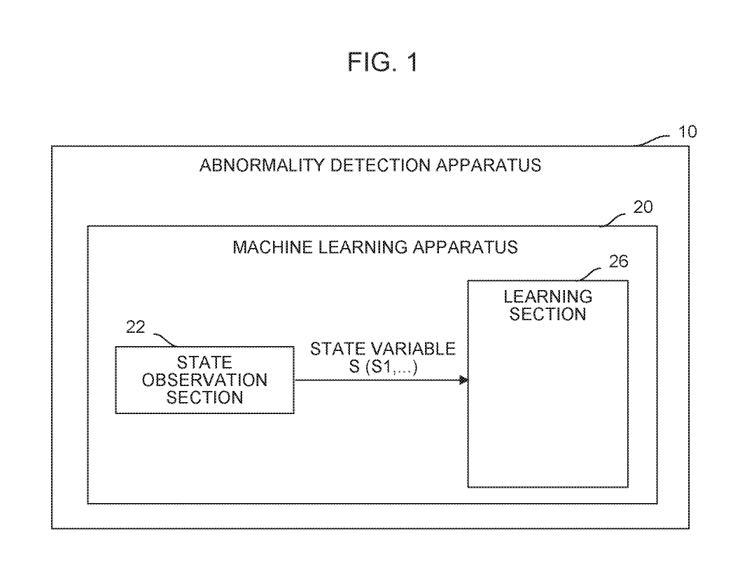

FIG. 1 is a schematic functional block diagram of an abnormality detection apparatus 10 according to a first embodiment. The abnormality detection apparatus 10 includes a machine learning apparatus 20 including software (learning algorithm and the like) and hardware (such as a CPU of a computer) for learning, by so-called machine learning by itself, waveform data for one machining cycle or a desired period concerning physical quantity values (current values and speed values of a spindle motor and a servo motor, vibration value detected from a machine tool, audible sound, and the like) detected in machining performed in a machine tool normally operating. Contents that the machine learning apparatus 20 of the abnormality detection apparatus 10 learns correspond to a model structure of waveform data for one machining cycle or a desired period concerning physical quantity values detected from a machine tool normally operating in machining.

As indicated by functional blocks in FIG. 1, the machine learning apparatus 20 of the abnormality detection apparatus 10 includes a state observation section 22 for observing a state variable S indicating the current environmental state which includes waveform data S1 indicating values (current values and speed values of a spindle motor and a servo motor, vibration value detected from a machine tool, audible sound, and the like) detected in machining by a machine tool (not shown) normally operating and a learning section 26 for using the state variable S to learn waveform data S1 obtained when a machine tool is normally operating.

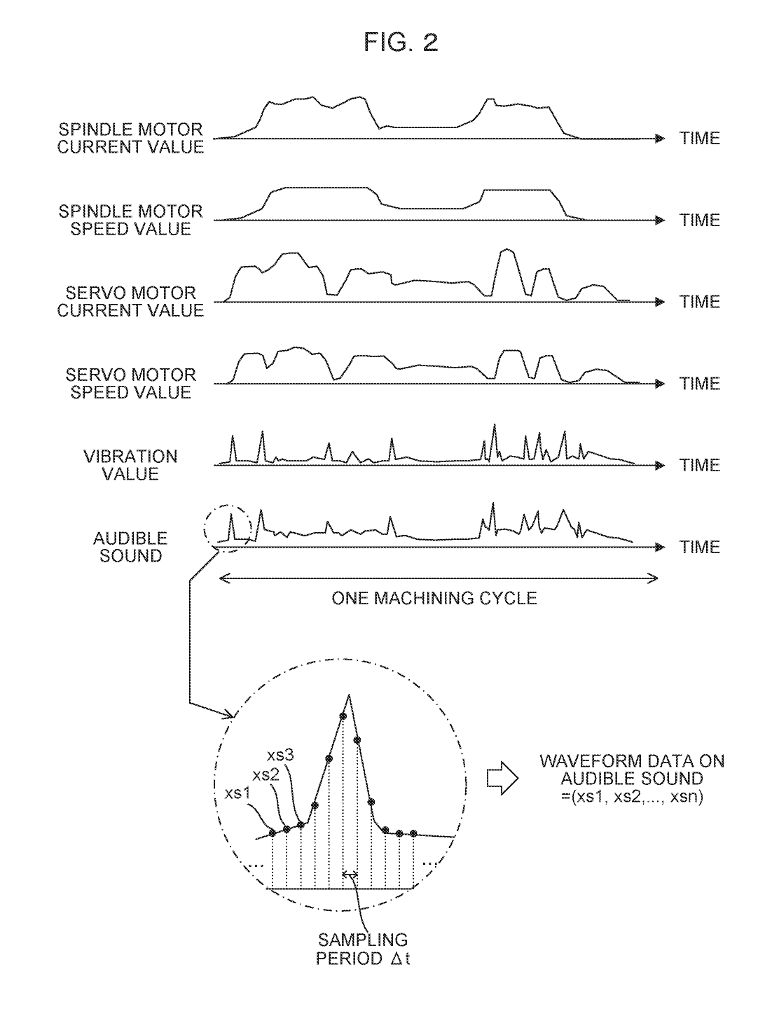

The state observation section 22 can be configured as, for example, one function of a CPU of a computer. Alternatively, the state observation section 22 can be configured as, for example, software that causes a CPU of a computer to work. The waveform data S1 of the state variable S that is observed by the state observation section 22 can be acquired by, for example, a plurality of measurement apparatuses (not shown) attached to a machine tool. The waveform data S1 include a current value of a spindle motor, a speed value of the spindle motor, a current value of a servo motor, a speed value of the servo motor, a vibration value detected from a machine tool, audible sound, and the like as illustrated in, for example, FIG. 2.

A current value and a speed value of a motor as waveform data S1 can be acquired as feedback values from a pulsecoder and the like attached to an amplifier and a motor. A vibration value as waveform data S1 can be acquired by a measurement apparatus such as an acceleration sensor, an AE sensor, a speed sensor, or an eddy-current sensor. Audible sound as waveform data S1 can be acquired using a measurement apparatus such as a microphone.

The state observation section 22 can acquire observed values as chronologically successive discrete values obtained by sampling the observed values with a predetermined sampling period Δt, and use the values as waveform data S1 as illustrated in, for example, FIG. 2. The state observation section 22 may use values acquired during one machining cycle as waveform data S1. The state observation section 22 may also use values acquired during a desired time period as waveform data S1. The state observation section 22 outputs waveform data concerning values acquired in the same time range in a single cycle of learning by the learning section 26 to the learning section 26.

As described above, during a period in which the machine learning apparatus 20 of the abnormality detection apparatus 10 is learning, a plurality of measurement apparatuses detect current values and speed values of motors, vibration value, audible sound, and the like in machining by a machine tool normally operating in the environment.

The learning section 26 can be configured as, for example, one function of a CPU of a computer. Alternatively, the learning section 26 can be configured as, for example, software that causes a CPU of a computer to work. The learning section 26 learns waveform data indicating values detected in machining by a machine tool normally operating in accordance with a desired learning algorithm generically called machine learning. The learning section 26 can repeatedly execute learning based on a data collection including the aforementioned state variable S with respect to machining by a machine tool normally operating.

By repeating such a learning cycle, the learning section 26 can configure implicit features of a data collection of waveform data for one cycle or a desired period concerning values detected from a machine tool normally operating in machining as clusters. When the learning algorithm is started, the clusters of the waveform data S1 is substantially unknown. The learning section 26 gradually recognizes features and configures clusters as the learning section 26 is learning. When the clusters of the waveform data S1 are interpreted to some reliable level, learning results repeatedly outputted by the learning section 26 can be used to determine whether the current state is a state in which machining is performed by a machine tool normally operating.

As described above, the machine learning apparatus 20 of the abnormality detection apparatus 10 is configured such that the learning section 26 learns waveform data concerning values detected from a machine tool normally operating in accordance with a machine learning algorithm using the state variable S observed by the state observation section 22. The waveform data S1 concerning values detected from a machine tool normally operating include temporal change in values detected from the machine tool normally operating, and also include relationships between values, such as speed values and current values of motors and a vibration value, detected at the same time. Accordingly, with the machine learning apparatus 20 of the abnormality detection apparatus 10, the fact that machining operation by a machine tool is within the range of normal operations can be automatically and correctly determined using learning results of the learning section 26, not by calculation or estimate.

If the fact that machining operation by a machine tool is within the range of normal operations can be automatically determined not by calculation or estimate, whether the current machining operation of a machine tool is normal or not can be rapidly determined by only acquiring waveform data (waveform data S1) concerning values acquired from the current machine tool.

In one modified example of the machine learning apparatus 20 of the abnormality detection apparatus 10, using a state variable S obtained for each of a plurality of machine tools having the same machine configuration, the learning section 26 can learn waveform data concerning values detected when each machine tool is normally operating. With this configuration, the quantity of a data collection including the state variable S which is obtained during a predetermined period can be increased. Accordingly, using a more diverse data collection as an input, the speed and reliability of the learning of waveform data concerning values detected from machine tools normally operating can be improved.

In the machine learning apparatus 20 having the above-described configuration, the learning algorithm executed by the learning section 26 is not particularly limited. For example, learning algorithms publicly known as machine learning such as unsupervised learning and neural networks can be employed.

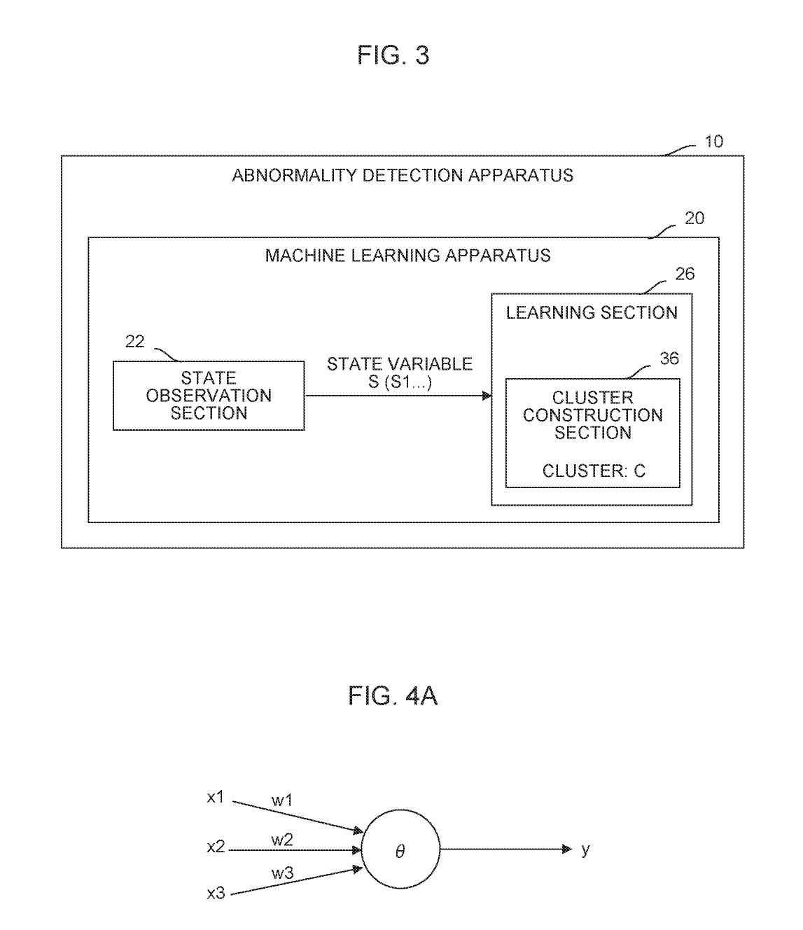

FIG. 3 shows another form of the abnormality detection apparatus 10 shown in FIG. 1 which includes the learning section 26 that executes unsupervised learning as another example of a learning algorithm.

Unsupervised learning is a method in which with a huge amount of inputted data sets given in advance, learning is performed by performing the classification or the like of each data set based on an attribute of each piece of data contained in the data set and extracting a feature of the data set. A feature of a data set here is a distribution state of each piece of data in the space of the data set with respect to a correlative pattern of time-series variation of a data item value of each piece of data included in the data set. A feature of each piece of data can be interpreted based on the feature of the data set.

In the machine learning apparatus 20 of the abnormality detection apparatus 10 shown in FIG. 3, the learning section 26 includes a cluster construction section 36 for constructing, from the state variable S, clusters of waveform data S1 concerning values detected when a machine tool is normally operating. The learning section 26 learns waveform data S1 concerning values detected when a machine tool is normally operating by the cluster construction section 36 which constructs (or reconstructs, if clusters C has already been constructed) clusters C based on a plurality of data sets of the waveform data S1 by using, for example, a publicly-known algorithm such as k-means clustering or a Gaussian mixture model.

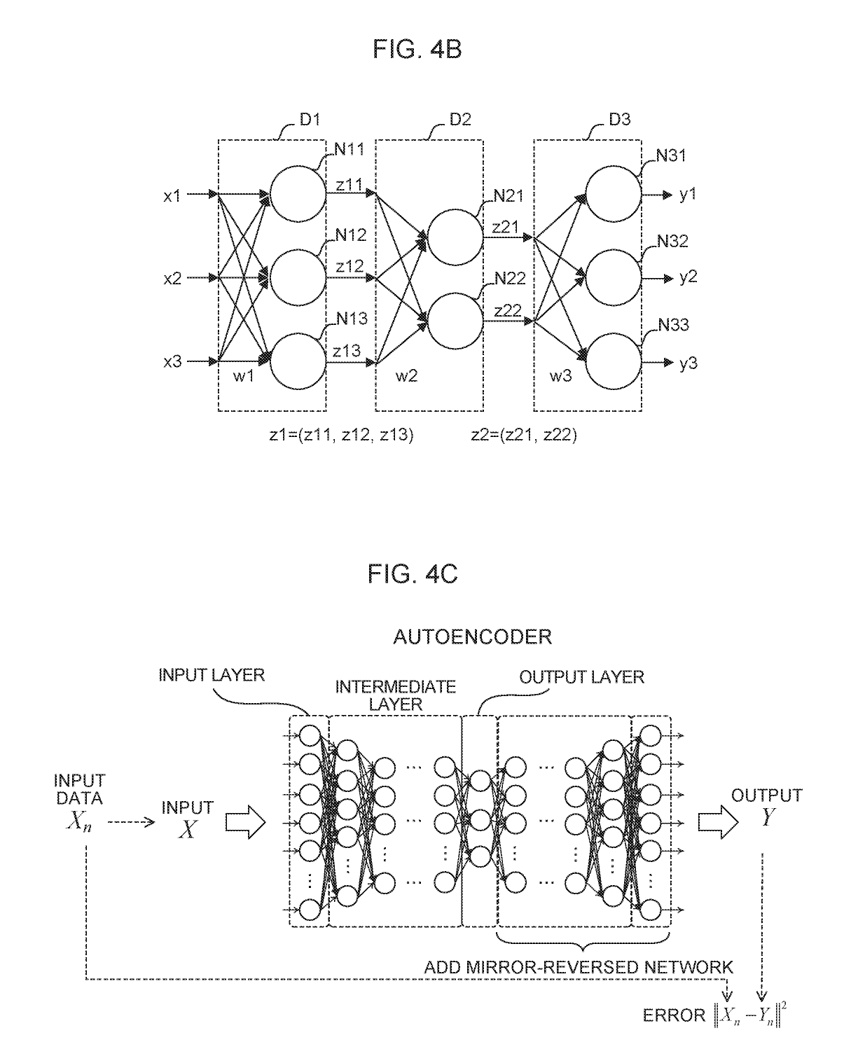

When the aforementioned unsupervised learning is performed, a neural network can be used. FIG. 4A schematically shows a model of a neuron. FIG. 4B schematically shows a model of a three-layer neural network configured by combining neurons shown in FIG. 4A. A neural network can be configured using, for example, an arithmetic unit, a memory unit, and the like that represent a model of a neuron.

The neuron shown in FIG. 4A is configured to output a result y for a plurality of inputs x (here, as one example, inputs x₁ to x₃). Each of the inputs xi to x₃ is multiplied by a weight w (w₁ to w₃) corresponding to the input x. This causes the neuron to output an output y expressed by the following equation (1). It should be noted that all of the input x, the output y, and the weight w are vectors in the equation (1). Further, θ is a bias, and fₖ is an activating function.

y=∫ₖ(Σᵢ₌₁ⁿxᵢwᵢ−θ) (1)

The three-layer neural network shown in FIG. 4B receives a plurality of inputs x (here, as one example, inputs x1 to x3) from the left side and outputs results y (here, as one example, results yl to y3) from the right side. In the illustrated example, the inputs x1, x2, and x3 are multiplied by corresponding weights (collectively expressed as w1), and each of the inputs x1, x2, and x3 is inputted to three neurons N11, N12, and N13.

In FIG. 4B, outputs from the neurons N11 to N13 are collectively represented by z1. z1 can be regarded as a feature vector obtained by extracting feature values of an input vector. In the illustrated example, elements of the feature vector z1 are multiplied by corresponding weights (collectively represented by w2), and each element of the feature vector z1 is inputted to two neurons N21 and N22. The feature vector z1 represents a feature between the weight w1 and the weight w2.

In FIG. 4B, outputs from the neurons N21 and N22 are collectively represented by z2. z2 can be regarded as a feature vector obtained by extracting feature values of the feature vector z1. In the illustrated example, elements of the feature vector z2 are multiplied by corresponding weights (collectively represented by w3), and each element of the feature vector z2 is inputted to three neurons N31, N32, and N33. The feature vector z2 represents a feature between the weight w2 and the weight w3. Finally, the neurons N31 to N33 output results y1 to y3, respectively.

FIG. 4C is a view showing a publicly-known autoencoder configured using a neural network. Using the autoencoder shown in FIG. 4C, unsupervised learning of waveform data S1 concerning values detected when the machine tool is normally operating can be performed.

In the machine learning apparatus 20 of the abnormality detection apparatus 10, using the state variable S as the input x, by the learning section 26 performing multi-layer structure calculation in accordance with the above-described neural network, a cluster to which waveform data S1 concerning values detected from the machine tool normally operating belong and the distance (result y) from the center of the cluster can be outputted. It should be noted that operation modes of the neural network include a learning mode and a value prediction mode. For example, weights w are learned using a learning data set in the learning mode, and the value of an action can be determined using the learned weights w in the value prediction mode. It should be noted that, in the value prediction mode, detection, classification, reasoning, and the like can also be performed.

The above-described configuration of the abnormality detection apparatus 10 can be described as a machine learning method (or software) that a CPU of a computer executes. This machine learning method is a machine learning method for learning waveform data S1 concerning values detected when the machine tool is normally operating, and includes a step of observing waveform data S1 concerning values detected when the machine tool is normally operating as a state variable S indicating the current environmental state in which machining by the machine tool is performed, by a CPU of a computer, and a step of constructing a cluster of waveform data S1 concerning values detected when the machine tool is normally operating to learn the waveform data S1.

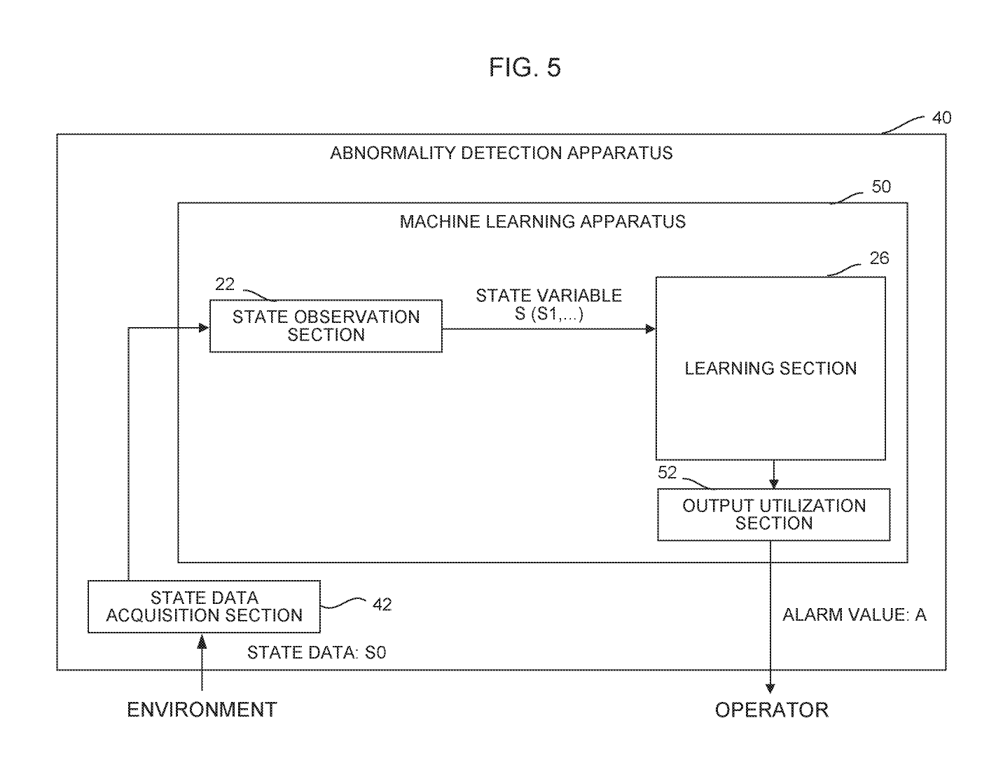

FIG. 5 shows an abnormality detection apparatus 40 according to a second embodiment. The abnormality detection apparatus 40 includes a machine learning apparatus 50, and a state data acquisition section 42 for acquiring waveform data S1 on a state variable S observed by the state observation section 22 as state data S0. The state data acquisition section 42 can acquire the state data S0 from the aforementioned plurality of measurement apparatuses attached to the machine.

The machine learning apparatus 50 of the abnormality detection apparatus 40 includes software (arithmetic algorithm or the like) and hardware (a CPU of a computer or the like) for outputting a determination as to whether the current operation of the machine tool is normal operation to an operator based on the learned waveform data concerning values detected when the machine tool is normally operating, in addition to software (learning algorithm or the like) and hardware (a CPU of a computer or the like) for learning waveform data S1 concerning values detected when the machine tool is normally operating by machine learning by itself. The machine learning apparatus 50 of the abnormality detection apparatus 40 can be configured such that one common CPU executes entire software including a learning algorithm, an arithmetic algorithm, and the like.

An output utilization section 52 can be configured as, for example, one function of a CPU of a computer. Alternatively, the output utilization section 52 can be configured as, for example, software that causes a CPU of a computer to work. The output utilization section 52 outputs an alarm value A indicating whether the current operation of the machine tool is normal operation or not to an operator through screen display with a display (not shown) of the abnormality detection apparatus 40, a lamp (not shown), audio output from a speaker (not shown), or the like, based on waveform data concerning values detected when the machine tool is normally operating, the waveform data learned by the learning section 26. The output utilization section 52 displays the operation state of the machine tool, and the operator can determine whether or not a workpiece has been machined by normal operation based on the displayed operation state.

The machine learning apparatus 50 of the abnormality detection apparatus 40 having the above-described configuration has effects equivalent to those of the aforementioned machine learning apparatus 20.

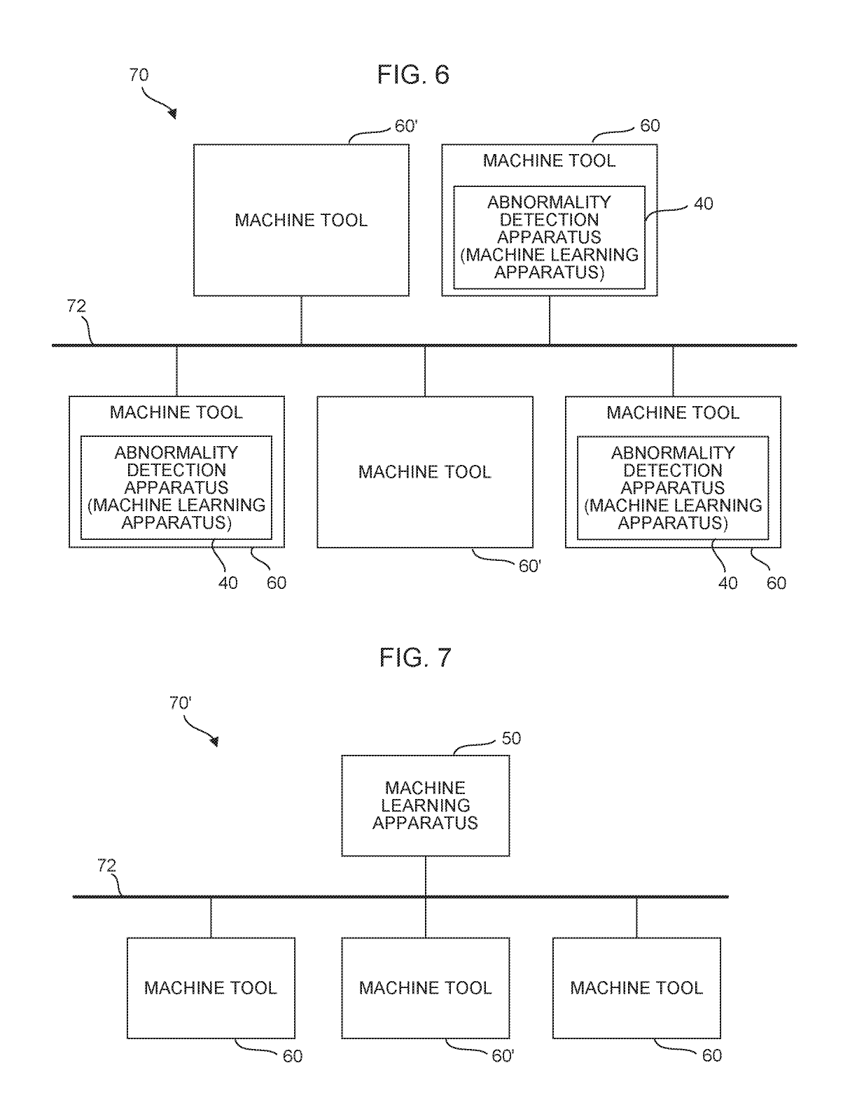

FIG. 6 shows a machining system 70 according to one embodiment which includes a machine tool 60. The machining system 70 includes a plurality of machine tools 60 and 60′ having the same mechanical configuration and a network 72 for connecting the machine tools 60 and 60′. At least one of the machine tools 60 and 60′ is configured as the machine tool 60 including the above-described abnormality detection apparatus 40. The machining system 70 may include the machine tool 60′ that does not include the abnormality detection apparatus 40. The machine tools 60 and 60′ have a general configuration of a machine tool which is necessary for machining a workpiece.

In the machining system 70 having the above-described configuration, the machine tool 60 including the abnormality detection apparatus 40, which is one of the machine tools 60 and 60′, can automatically and correctly determine whether the machine tools 60 and 60′ are normally operating with respect to waveform data concerning values detected from the machine tools 60 and 60′ using learning results of the learning section 26, not by calculation or estimate. Further, the abnormality detection apparatus 40 of at least one machine tool 60 can be configured to learn waveform data concerning values detected from machine tools normally operating, the waveform data being common to all of the machine tools 60 and 60′, based on a state variable S obtained for each of other machine tools 60 and 60′ so that learning results may be shared by all of the machine tools 60 and 60′. Accordingly, with the machining system 70, using a more diverse data collection (including a state variable S) as inputs, the speed and reliability of the learning of waveform data concerning values detected from machine tools normally operating can be improved.

FIG. 7 shows a machining system 70′ according to another embodiment which includes the machine tool 60′. The machining system 70′ includes a machine learning apparatus 50 (or 20), a plurality of machine tools 60′ having the same mechanical configuration, and a network 72 for connecting the machine tools 60′ and the machine learning apparatus 50 (or 20).

In the machining system 70′ having the above-described configuration, the machine learning apparatus 50 (or 20) learns waveform data concerning values detected from machine tools normally operating, the waveform data being common to all of the machine tools 60′, based on a state variable S obtained for each of the machine tools 60′, and can automatically and correctly determine whether or not the machine tool 60′ is normally operating with respect to waveform data concerning values detected from the machine tools 60′ using the learning results, not by calculation or estimate.

The machining system 70′ can have a configuration in which the machine learning apparatus 50 (or 20) exists on a cloud server prepared on the network 72. This configuration allows a necessary number of machine tools 60′ to be connected to the machine learning apparatus 50 (or 20) when necessary, irrespective of the respective locations of the machine tools 60′ or timing.

Operators working with the machining systems 70 and 70′ can determine whether the achievement of the learning of waveform data concerning values detected from machine tools normally operating by the machine learning apparatus 50 (or 20) (that is, the reliability of determination on operation normality based on waveform data concerning values detected from machine tools) has reached a required level or not, at an appropriate time after the machine learning apparatus 50 (or 20) has started learning.

While embodiments of the present invention have been described above, the present invention is not limited to the above-described exemplary embodiments, and can be carried out in various aspects by making appropriate modifications thereto.

For example, learning algorithms executed by the machine learning apparatuses 20 and 50, an arithmetic algorithm executed by the machine learning apparatus 50, control algorithms executed by the abnormality detection apparatuses 10 and 40, and the like are not limited to the above-described ones, and various algorithms can be employed.

As learning algorithms executed by the machine learning apparatuses 20 and 50, supervised learning can also be used.

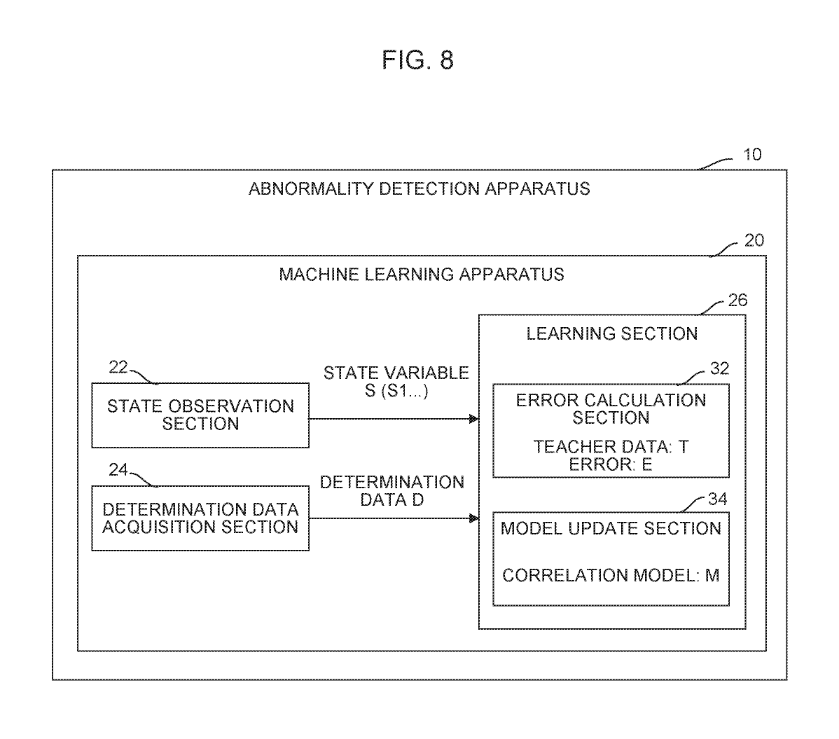

FIG. 8 shows another form of the abnormality detection apparatus 10 shown in FIG. 1 which includes the learning section 26 that executes supervised learning as another example of a learning algorithm. Supervised learning is a method for learning a correlation model for estimating a required output for a new input by preparing a huge amount of known data sets (referred to as teacher data), each of which includes an input and an output corresponding thereto, in advance and recognizing a feature implying the correlation between input and output from the teacher data.

In the machine learning apparatus 20 of the abnormality detection apparatus 10 shown in FIG. 8, the learning section 26 includes an error calculation section 32 for calculating an error E between a correlation model M for deriving the normality of operation of the machine tool from waveform data concerning values obtained from a machine tool normally operating based on a state variable S and determination data D and a correlation feature recognized by teacher data T prepared in advance, and a model update section 34 for updating the correlation model M so that the error E may be reduced. The learning section 26 learns the correlation between waveform data concerning values detected from a machine tool performing machining operation and the normality of operation of the machine tool by the model update section 34 repeating the updating of the correlation model M.

An initial value of the correlation model M is expressed with the correlation with respect to the state variable S and determination data D simplified, for example, by a linear function, and is given to the learning section 26 before the start of supervised learning. The teacher data T can be configured using, for example, empirical values accumulated by recording determinations as to the normality of operation of the machine tool made in past machining by the machine tool by an expert operator, and are given to the learning section 26 before the start of supervised learning. The error calculation section 32 recognizes a correlation feature implying the correlation between waveform data concerning values detected from a machine tool performing machining operation and a determination as to the normality of operation of the machine tool based on a huge amount of teacher data T given to the learning section 26, and finds an error E between the correlation feature and a correlation model M corresponding to the state variable S in the current state and determination data D. The model update section 34 updates the correlation model M so that the error E may be reduced, in accordance with, for example, predetermined update rules.

In the next learning cycle, using the state variable S and determination data D changed by testing machining operation by the machine tool in accordance with the updated correlation model M, the error calculation section 32 finds an error E with respect to the correlation model M corresponding to the changed state variable S and determination data D, and the model update section 34 updates the correlation model M again. This gradually reveals the correlation between the current environmental state (waveform data concerning values detected from a machine tool that is performing machining operation) that has been unknown and a determination on the current environmental state (determination on operation normality of the machine tool).

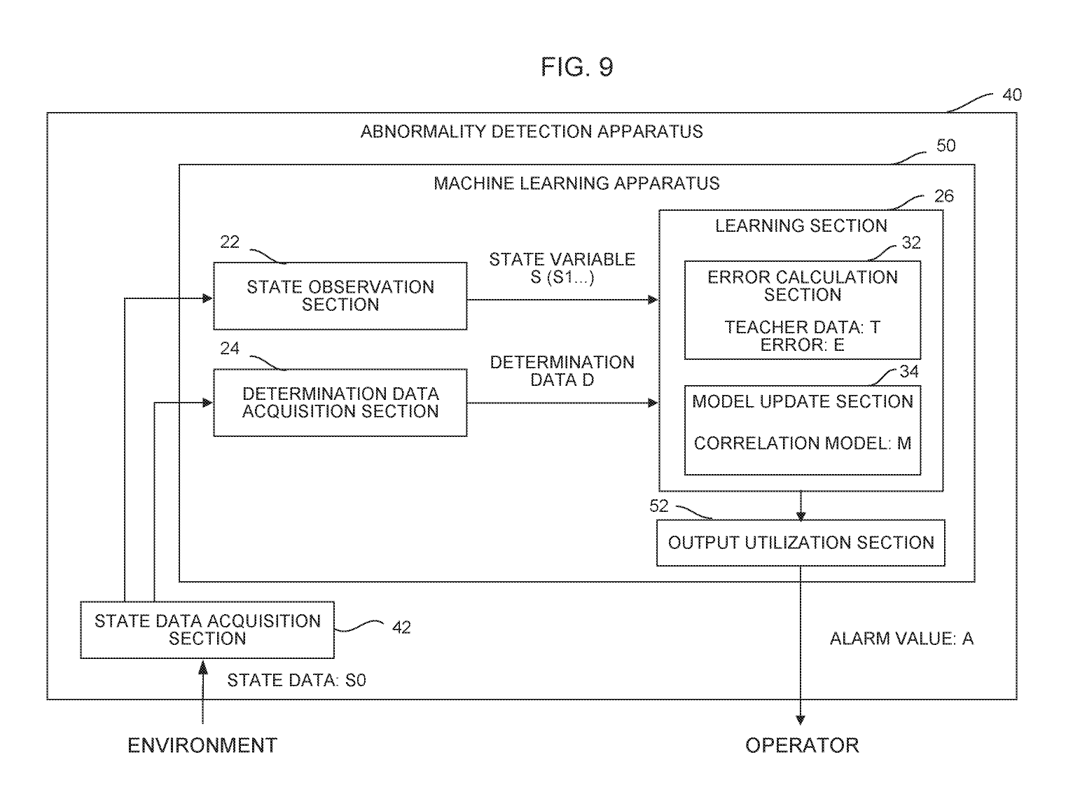

FIG. 9 shows another form of the abnormality detection apparatus 40 shown in FIG. 5 and a configuration example in which the learning section 26 that executes supervised learning as another example of a learning algorithm is included. In the configuration in FIG. 9, the output utilization section 52 outputs an alarm value A indicating whether the current operation of the machine tool is normal operation to an operator on a display screen of a display (not shown) of the abnormality detection apparatus 40, a lamp (not shown), audio output from a speaker (not shown), or the like, based on waveform data concerning values detected when the machine tool is normally operating, the waveform data learned by the learning section 26. The output utilization section 52 displays the operation state of the machine tool, and the operator can determine whether a workpiece is machined by normal operation based on the displayed operation state.

1. An abnormality detection apparatus for detecting an abnormality of a machine tool configured to machine a workpiece, the abnormality detection apparatus comprising:
a machine learning apparatus for learning waveform data concerning a physical quantity detected when the machine tool is normally operating, wherein
the machine learning apparatus includes
a state observation section for observing the waveform data concerning the physical quantity detected when the machine tool is normally operating, as a state variable indicating a current environmental state, and
a learning section for learning a feature of the waveform data concerning the physical quantity detected when the machine tool is normally operating, using the state variable.

2. The abnormality detection apparatus according to claim 1, wherein the learning section includes a cluster construction section for constructing a cluster of the waveform data concerning the physical quantity detected when the machine tool is normally operating.

3. An abnormality detection apparatus for detecting an abnormality of a machine tool configured to machine a workpiece, the abnormality detection apparatus comprising:
a machine learning apparatus for learning waveform data concerning a physical quantity detected when the machine tool is normally operating, wherein
the machine learning apparatus includes
a state observation section for observing waveform data concerning the physical quantity detected when the machine tool is operating, as a state variable indicating a current environmental state,
a determination data acquisition section for acquiring determination data indicating normality of operation of the machine tool, and
a learning section for performing learning by associating the waveform data concerning the physical quantity detected when the machine tool is operating with the normality of the operation of the machine tool, using the state variable and the determination data.

4. The abnormality detection apparatus according to claim 3, wherein
the learning section includes
an error calculation section for calculating an error between a correlation model for deriving the normality of the operation of the machine tool from the waveform data concerning the physical quantity detected when the machine tool is operating and a correlation feature recognized from teacher data prepared in advance, based on the state variable and the determination data, and
model update section for updating the correlation model to reduce the error.

5. The abnormality detection apparatus according to claim 1, wherein the learning section has a multi-layer structure to calculate the state variable.

6. The abnormality detection apparatus according to claim 1, further comprising:
an output utilization section for outputting an operation state of the machine tool based on a learning result by the learning section and the state variable obtained when the machine tool is operating.

7. The abnormality detection apparatus according to claim 1, wherein the learning section learns waveform data concerning a physical quantity which is detected when operation is being normally performed and which is common to a plurality of machine tools, using the state variable obtained for each of the plurality of machine tools.

8. A machine learning apparatus for learning waveform data concerning a physical quantity detected when a machine tool configured to machine a workpiece is normally operating, the machine learning apparatus comprising:
a state observation section for observing waveform data concerning a physical quantity detected when the machine tool is normally operating, as a state variable indicating a current environmental state; and
a learning section for learning a feature of the waveform data concerning the physical quantity detected when the machine tool is normally operating, using the state variable.

9. A machine learning apparatus for learning waveform data concerning a physical quantity detected when a machine tool configured to machine a workpiece is normally operating, the machine learning apparatus comprising:
a state observation section for observing waveform data concerning a physical quantity detected when the machine tool is operating, as a state variable indicating a current environmental state;
a determination data acquisition section for acquiring determination data indicating normality of operation of the machine tool; and
a learning section for performing learning by associating the waveform data concerning the physical quantity detected when the machine tool is operating with the normality of the operation of the machine tool, using the state variable and the determination data.
